(19) United States
(12) Patent Application Publication
(10) Pub. No.: US 2017/0286561 A1
(43) Pub. Date: Oct. 5, 2017

(54) SYSTEM AND METHOD TO ACCELERATE ACCESSING CONTENT

(71) Applicant: International Business Machines Corporation, Armonk, NY (US)

(72) Inventors: Kun Bai, Hartsdale, NY (US); Di Ling Chen, Beijing (CN); Christian Benjamin Kau, Los Altos, CA (US); Zhi Cheng Liu, Waitara (AU); Patrick Joseph O'Sullivan, Ballsbridge (IE)

(21) Appl. No.: 15/090,007

(22) Filed: Apr. 4, 2016

(51) Int. Cl. G06F 17/30; G06F 3/0488; G06F 3/0482

(52) U.S. Cl. CPC G06F 17/30902; G06F 3/0482; G06F 3/0488

(57) ABSTRACT

A native application executing on a user's device can receive a selection of one or more content items. The one or more content items can be selected via a cursor positioning device or via a gesture on a touch screen. In some aspects, the type of gesture can indicate a priority for loading the one or more content items onto the user's device. The one or more content items can be loaded while other content items are being processed by the user's device.

### BACKGROUND

Embodiments of the inventive subject matter generally relate to the field of computer applications and, more particularly, to accelerating access of content by computer applications.

People rely on network connected applications for many aspects of their lives. For example, many people use network connect applications for banking, social networking, word processing, travel planning, education, shopping etc. Network technologies have spread from personal computers to smart phones and other personal digital assistants. Further, increased bandwidth available to network connected devices has made it feasible to provide more rich content such as video and audio content to users. However, utilization of rich content typically requires downloading large amounts of data. Thus, it can take a relatively long time to acquire the content used by network aware applications.

### SUMMARY

Systems, methods and computer program products of varying scope accelerate loading content from a network connected source. A native application receives an indication of one or more selected user interface elements. Based on the selection, the native application determines one or more content items to be loaded. The native application can then change a priority associated with loading the one or more content items.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a system for accelerating content access for a native application.

FIG. 2 depicts an example user interface for a native application.

FIG. 3 depicts an alternative example user interface for a native application.

FIG. 4 depicts further aspects of the alternative example user interface of FIG. 3.

FIG. 5 depicts still further aspects of the alternative example user interface of FIG. 3.

FIG. 6 depicts a system for accelerating content access according to alternative aspects of the disclosure.

FIG. 7 depicts an example user interface for a native application depicted in FIG. 6.

FIG. 8 is a flow chart illustrating operations for a method of accelerating content access in native applications.

FIG. 9 depicts an example computer system.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

In various aspects of the disclosure, a native application executing on a user's device can receive a selection of one or more content items. The one or more content items can be selected via a cursor positioning device or via a gesture on a touch screen. In some aspects, the type of gesture can indicate a priority for loading the one or more content items onto the user's device. The one or more content items can be loaded while other content items are being processed by the user's device. For example, the user may be viewing a video, and may select other videos to be loaded for future viewing.

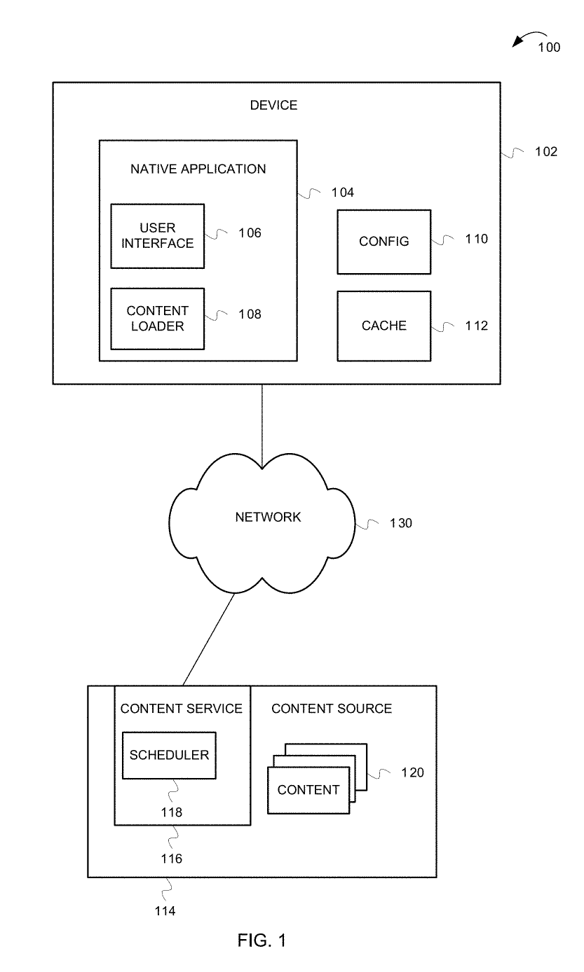

FIG. 1 depicts a system 100 for accelerating content access for a native application. In some aspects, system 100 includes a device 102 communicably coupled to a content source 114 via network 130. Network 130 can be a wired network, a wireless network, or a combination of multiple wired and/or wireless networks. In some aspects, network 130 can be the Internet.

Device 102 can be any type of computing device capable of executing a native application 104. Examples of such devices include smart phones, personal digital assistants, music players, set top boxes, personal computers, tablet computers, laptop computers etc. The inventive subject matter is not limited to any particular type of computing device.

Content source 114 can be a server computer that provides content 120 to client devices such as device 102. Content 120 can be any type of digital content. Examples of such content include audio content, video content, image content, database content, multimedia content, application installation package content, executable file content etc. The inventive subject matter is not limited to any particular type of content 120.

Device 102 includes a native application 104 that can load content 120 from content source 114 for presentation or use on device 102, where the primary functionality of the native application is provided on the device (as opposed to applications such as browser applications that primarily rely on functionality being provided by a server computer). For example, native application 104 may be a video display application that downloads video content from a content source 114 for display on device 102. Examples of such video display applications include the YouTube® video player application, the Hulu® video player application, the Netflix® video player application etc. that are available on smart phone devices and tablet devices running the Android operating system or IOS operating system. Other examples of native applications include image viewer and manipulation applications, installation applications (i.e., applications that install other applications), music player applications etc. The inventive subject matter is not limited to any particular type of native application.

Native application 104 can include a user interface 106 and a content loader 108. User interface 106 can provide an interface that handles input and output between a user of device 102 and the device. For example, on devices that have a touchscreen interface, user interface 106 may receive indications of touches and gestures on the touchscreen and can interpret the touches and gestures as commands to select user interface elements or manage the presentation of user interface elements on a touchscreen of device 102. Similarly, user interface 106 may receive input from a cursor positioning device such as a mouse and/or button presses to select user interface elements or manage the presentation of user interface elements on a display screen of device 102. In response to selection, either by gestures or by the cursor positioning device, the user interface 106 can provide the native application 104 identifiers associated with the user interface elements that have been included in the selection.

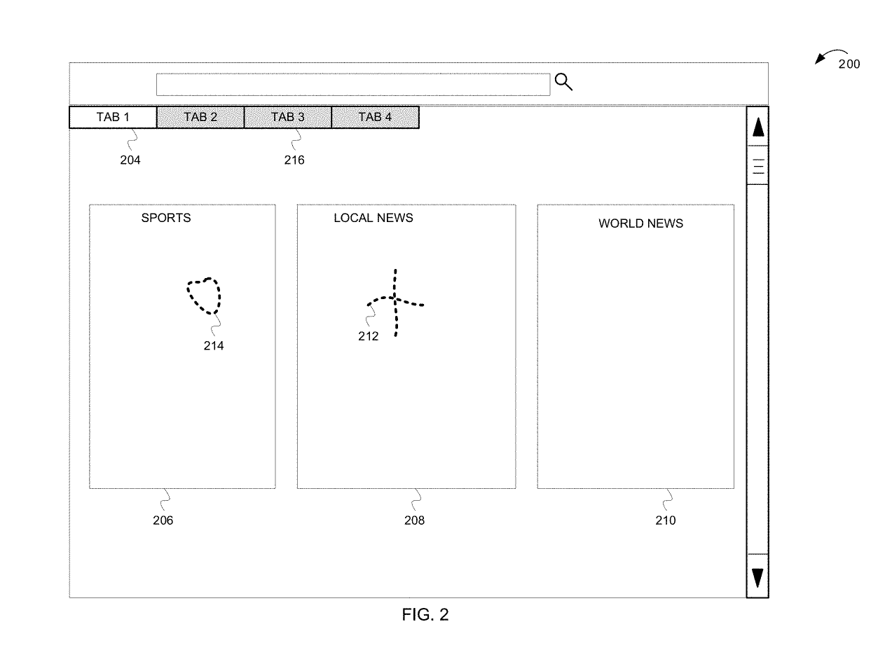

Content loader 108 loads content for use by native application 104. In some aspects, content loader 108 can pre-load content that has been selected by a user via user interface 106. The content can be pre-loaded while the user's device 102 is processing current content. For example, in the case of a video player application, a user can be viewing a current video, and can utilize the user interface 106 to select one or more other videos for loading by content loader 108 so that the video can be ready for viewing when the user has finished viewing the current video. In addition to selection of videos to pre-load, the user interface 106 may provide a way to indicate performance characteristics that are to be associated with the pre-loading. Examples of such performance characteristics include priority, processor loading, memory loading, and memory bandwidth characteristics. Example user interfaces and user interactions are discussed below with reference to FIGS. 2-5.

Content loader 108 can request content 120 from a content source 114 by issuing requests for the content 120 to a content service 116. In some aspects, content service 116 can be a web service. A web service is a service that is typically provided by a one device to another device, where communication between the devices can use web based technologies. For example, web based technologies such as HTTP can be used to transfer files in a machine readable format such as XML or JSON. In some aspects, the content service 116 can utilize AJAX, REST, ATOM or other web service technologies to retrieve and communicate content 120 to content loader 108.

Cache 112 can be a memory storage area to store content that is pre-loaded by content loader 108. In the example where native application 104 is a video player application, cache 112 can be used to store video content that is pre-loaded and is to be available when the user finishes a current video.

Configuration data 110 can store policies and service level agreement information related to loading content by content loader 108.

In some aspects, content service 116 can include a content scheduler 118. Content scheduler 118 can receive performance characteristics from content loader 108, and use the performance characteristics to control how content 120 is transferred to content loader 108. For example, the content scheduler 118 can use the performance characteristics to assign priorities and other performance characteristics to content that is transferred to content loader 108 such that some content may be transferred ahead of the delivery of other content.

FIG. 2 depicts an example user interface 200 for a native application 104. For the purposes of the example, assume that native application 104 is an application that provides news content (video, text, audio clips etc.) to a user. The example user interface 200 has tabs and panels that allow the user to select news items to view. In this example, a current tab 204 has three panels: a sports panel 206 that can contain news items related to sports, a local news panel 208 that can contain news items that are local in nature, and a world news panel 210 that can contain news items that are from around the world. Assume that a user is mostly interested in local news items, and does not like to view sports news items. The user can utilize user interface 106 to indicate that content associated with news items appearing in local news panel 208 is to be pre-loaded so that it is readily available. The user can make this indication using a gesture 212 in the form of a plus sign. Further, the user can indicate that content related to sports news in sports panel 206 is not to be pre-loaded by using a gesture 214 in the form of a zero, indicating that content associated with this panel is not to be pre-loaded. In response to the user's gestures, a content loader 108 can issue requests to content service 116 so that content related to news items in local news panel 208 is pre-loaded. Content loader 108 can also adjust performance characteristics associated with the content in local news panel 208 so that the local news content is loaded at a higher priority, is allowed to use more processor time, is allowed to use more network bandwidth etc. so that the content is loaded ahead of other content. Those of skill in the art having the benefit of the disclosure will appreciate that other gestures and other user interface mechanisms can be used to indicate content that is to be pre-loaded and/or to adjust performance characteristics associated with loading content. For example, a user can user a cursor positioning device to cause a drop down box to appear over user interface elements. The drop down box can include user interface elements that the user can utilize to select the content for pre-loading, and to adjust performance characteristics associated with pre-loading the content. As an example, the user could “right click” over tab 216 to cause a drop down box to appear that would allow the user to indicate that content associated with tab 216 is to be pre-loaded. In addition, the user can select a priority to be associated with pre-loading the selected content.

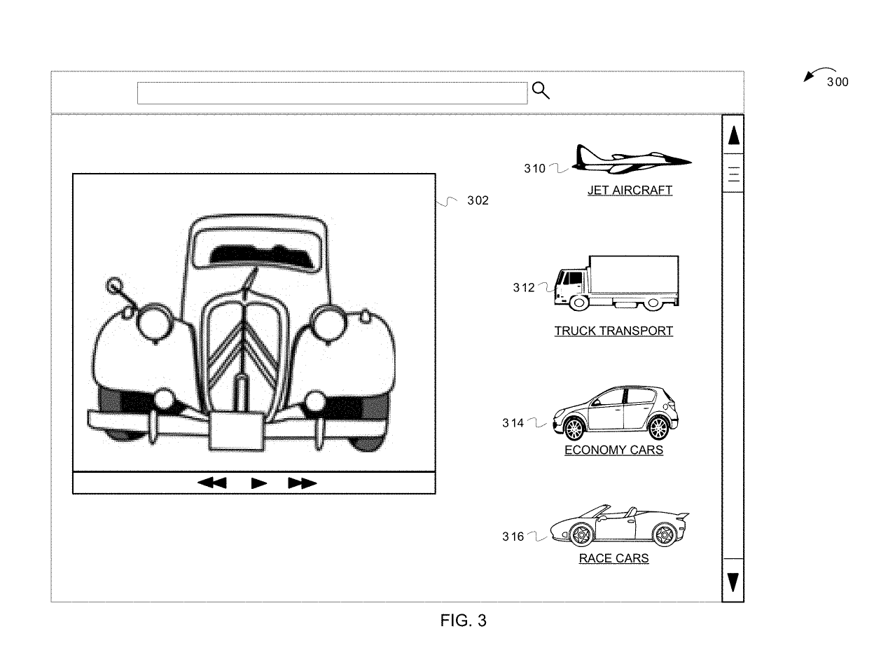

FIG. 3 depicts an alternative example user interface 300 for a native application 104. Assume that example user interface 300 is an interface for a video player application. Further assume that a user is viewing a current video 302 related to classic cars. The video player application also presents user interface icons associated with video content that the user may be interested in, such as a jet aircraft icon 310, a truck transportation icon 312, an economy cars icon 314, and a race cars icon 316.

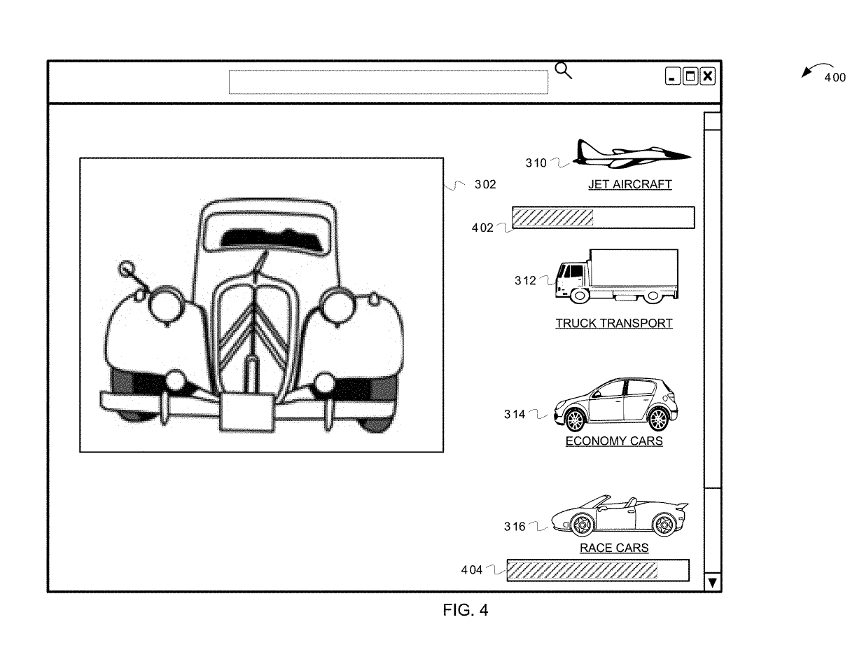

FIG. 4 depicts further aspects of the alternative example user interface 300 of FIG. 3. Assume that in the user interface depicted in FIG. 3, that the user has indicated, either via a gesture or via a cursor positioning device, that the video content associated with the jet aircraft icon 310 and the race cars icon 316 is to be pre-loaded so that the user can view the videos after finishing the current video 302 without having to wait for the video content to load. In some aspects, a progress indicator can be used to indicate the progress of the pre-loading of the selected video content. For example, a progress bar (e.g. bars 402 and 404) can be presented either near or over the user interface elements representing the content that is currently being pre-loaded. In some aspects, the user can select the progress bar which can cause a user interface element such as a drop down box to appear that can allow the user to adjust the performance characteristics associated with pre-loading the content. For example, the user can adjust the priority of the pre-loading to indicate that some content is to be pre-loaded faster than other content that is also being pre-loaded.

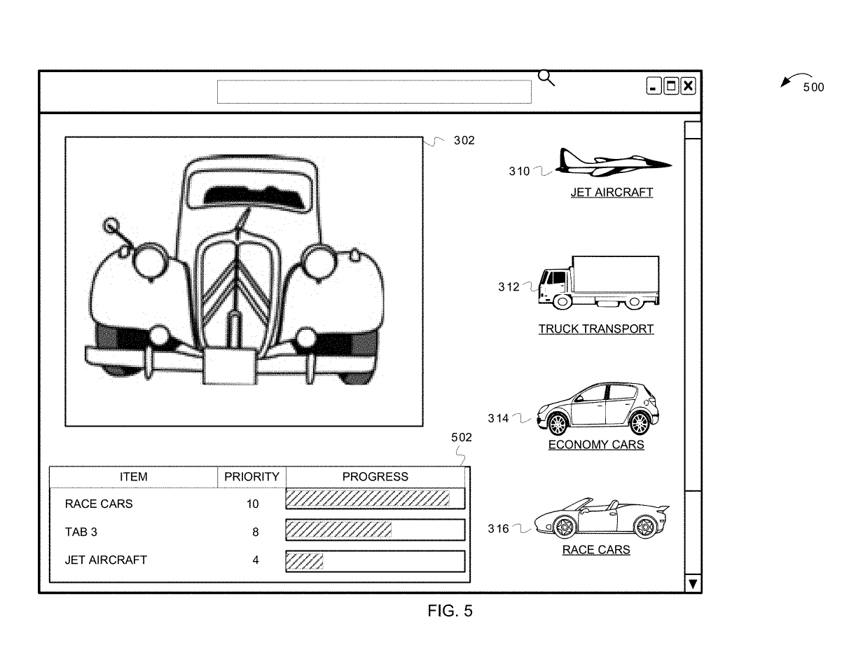

FIG. 5 depicts still further aspects of the alternative example user interface 300 of FIG. 3. Again, assume that in the user interface depicted in FIG. 3, that the user has indicated, either via a gesture or via a cursor positioning device, that the video content associated with the jet aircraft icon 310 and the race cars icon 316 is to be pre-loaded. In this example user interface, a table 502 can be used to indicate content items that are being pre-loaded, along with priority information and a progress bar associated with the pre-loading of the content. In some aspects, the user can drag and drop items in the table to readjust the relative priorities of the preloading of the content. For example, the use could drag the row for the race car item and drop it below the row associated with the jet aircraft item to indicate that the priority associated with pre-loading the race car content is to be lower than the priority associated with pre-loading the tab 3 content and the jet aircraft content.

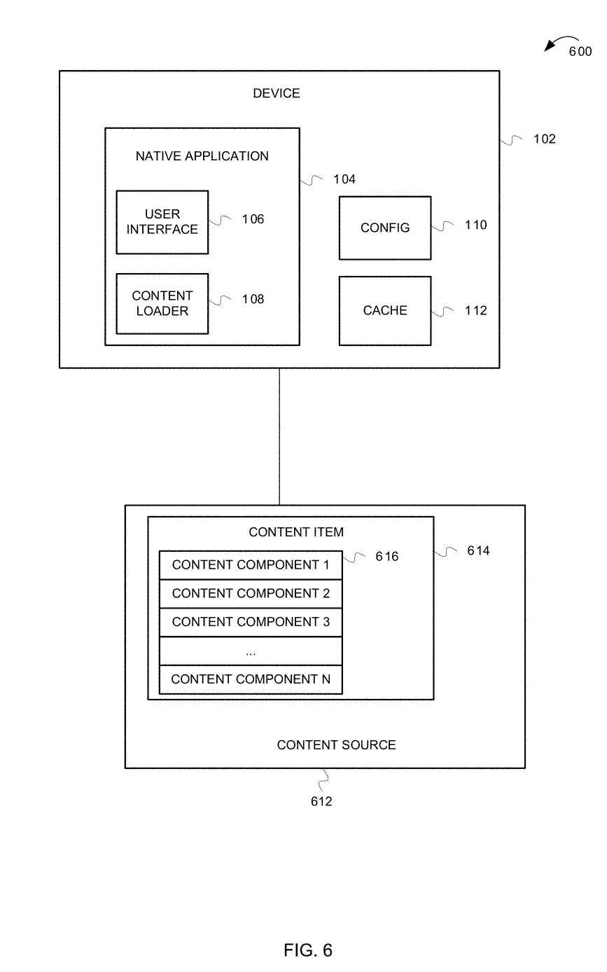

FIG. 6 depicts a system 600 for accelerating content access according to alternative aspects of the disclosure. In system 600, the components of device 102 are the same those described with reference to FIG. 1. In system 600, content source 612 provides content items 614 that can be composed of multiple content components 616. As an example, a content item 614 can be a satellite image having multiple tiles that are each a separate image component. Thus the content components 616 can each be a tile associated with the satellite image. Alternatively, the content item can be an image of a human body produced by an x-ray, CT scanner, PET scanner, Mill scanner etc., and each tile can be a separate component of the image. Other examples can include a video series having multiple episodes, an audio topic having multiple episodes (e.g., multiple podcasts associated with a topic) etc. In system 600, content loader 108 can load the content item 614, and can load individual components 616 of the content item 614 in accordance with a selected performance characteristic. As with system 100 of FIG. 1, the selection can be based on gestures on a touch screen, or on input provided by a cursor positioning device.

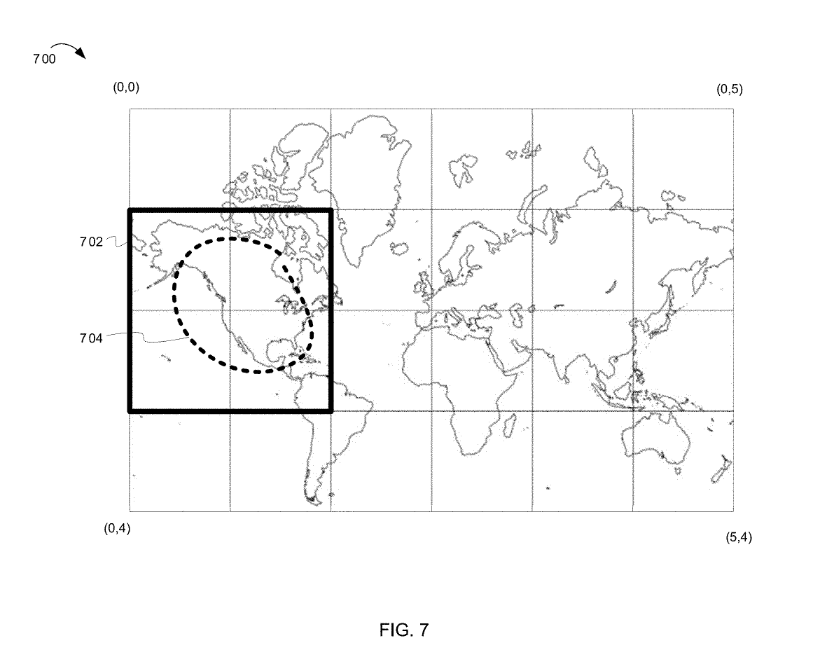

FIG. 7 depicts an example user interface 700 for a native application depicted in FIG. 6. In the example, user interface 700 presents a map of the world composed of multiple satellite images of the world. A user can use a gesture 704 to indicate that particular satellite images are to be loaded faster, or are to be loaded at a higher resolution. For example, the user can use a gesture 704 that indicates tiles that are to be loaded at a higher resolution than the other component tiles. In the example, tiles associated with user interface elements that have been touched by the circular gesture 704 are loaded at a higher resolution. Alternatively, the user interface can select user interface elements that are totally enclosed by a circular gesture. Further, a cursor positioning device could be used to select tiles that are to be loaded at a higher resolution.

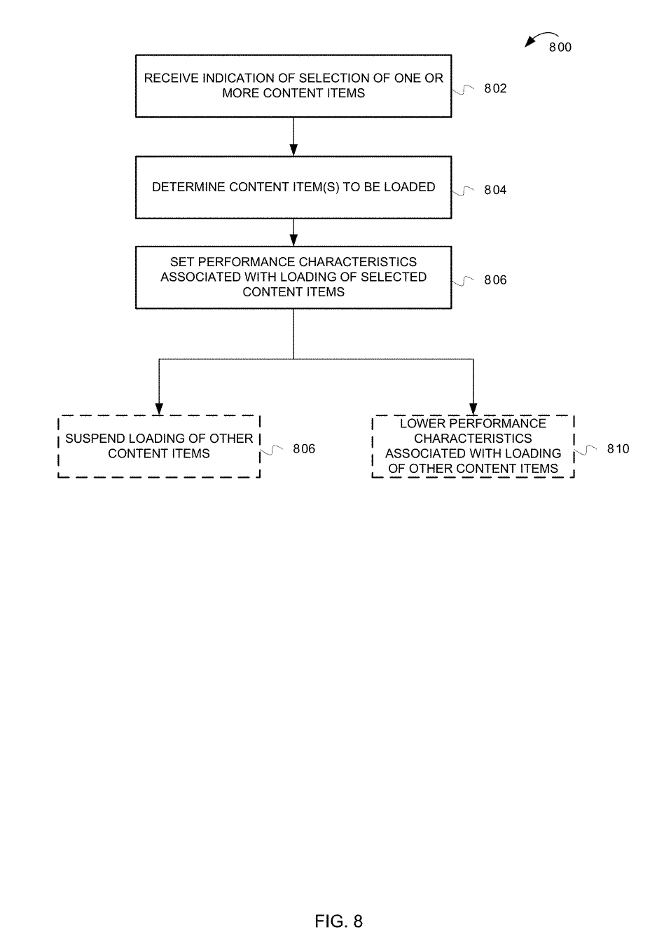

FIG. 8 is a flow chart 800 illustrating operations for a method of accelerating content access in native applications.

At block 802, an indication of selected user interface elements is received. For example, a user interface 106 can indicate that one or more user interface elements on a screen have been selected. As discussed above, the user interface elements can be selected via gestures on a touch screen, or via a cursor positioning device. The user interface elements can be selected while current content is being processed.

At block 804, the content associated with the selected user interface elements can be requested for loading into a device 102. In some aspects, the requests can be issued while other content is either loading or being used by a native application 104. For example, a user can select videos to be loaded while viewing a current video.

At block 806, the content loader can set performance characteristics associated with the selected content. For example, the content loader can cause the selected content to be loaded at a higher priority than other content that is being loaded by native application 104. Similarly, the content loader can cause the selected content to be assigned more processor time, more network bandwidth, or more memory resources than other content that is being loaded onto device 102.

In some aspects, content loader can communicate the desired performance characteristics to a content server (e.g., content service 116 on a content server). The content server can the adjust the performance characteristics associated with providing the content to the native application 104 in accordance with the desired characteristics.

Optionally, at block 806, the loading of content other than the selected content can be suspended until the selected content has finished loading. For example, content loader 108 of native application 104 or content scheduler 118 of content service 116 can cause loading of content other than the selected content to be temporarily suspended.

As an alternative optional operation, the performance characteristics associated with loading content other than the selected content can be lowered. For example, content loader 108 or scheduler 118 of content service 116 can cause the other content to be loaded at a lower priority, and/or cause the loading of the other content to use less processor time, less memory resources, or less network bandwidth than the selected content.

The selected content can be loaded while current content is being processed by the user's device 102. For example, a current video may be presented on the device 102 while selected videos are loaded onto device 102 for future viewing. Alternatively, device 102 may be installing a current application while selected applications are loaded onto device 102 for future installation.

It should be noted that while the above examples have been presented in the context of a user selecting content the content, alternative mechanisms can be used to cause content to be pre-loaded, and to load the content using pre-defined performance characteristics. For example, policies and/or service level agreements can be associated with particular content, particular types of content, particular content services, and/or particular content sources. These policies and service level agreements can be stored on a device 102, for example in configuration data 110. Thus once selected, the desired loading performance characteristics can be used in subsequent sessions of native application 104 on device 102 and automatically applied, thereby eliminating the need for the user to select content that is to be pre-loaded or loaded at a higher priority than other content.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

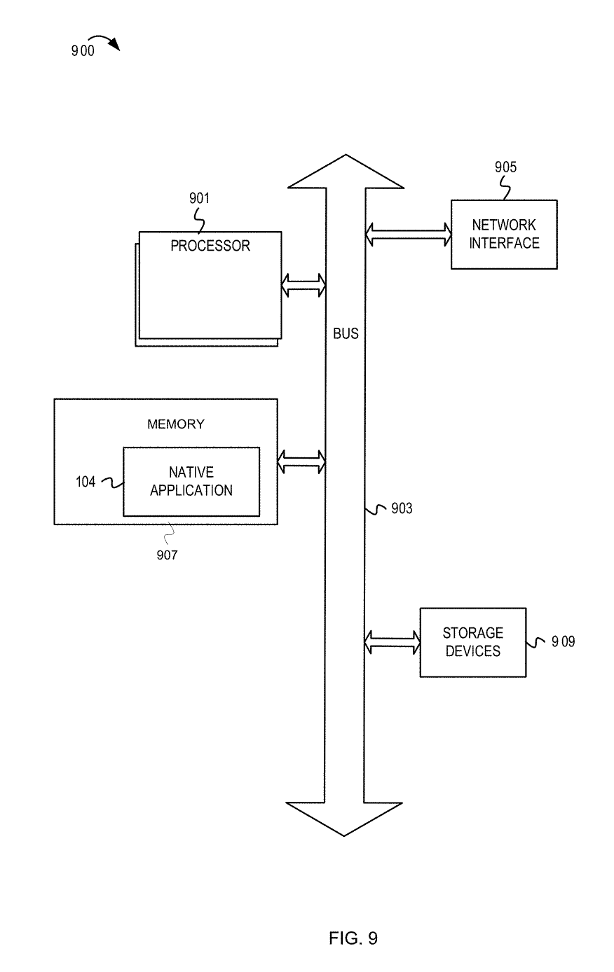

FIG. 9 depicts an example computer system. A computer system includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport®, InfiniBand®, NuBus, etc.), a network interface 905 (e.g., an ATM interface, an Ethernet interface, a Frame Relay interface, SONET interface, wireless interface, etc.), and a storage device(s) 909 (e.g., optical storage, magnetic storage, etc.). The system memory 907 embodies functionality to implement embodiments described above. The system memory 907 may include one or more functionalities that facilitate accelerating content loading by pre-loading content or by adjusting performance characteristics associated with loading content. Any one of these functionalities may be partially (or entirely) implemented in hardware and/or on the processor unit 901. For example, the functionality may be implemented with an application specific integrated circuit, in logic implemented in the processor unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901, the storage device(s) 909, and the network interface 905 are coupled to the bus 903. Although illustrated as being coupled to the bus 903, the memory 907 may be coupled to the processor unit 901.

While the embodiments are described with reference to various implementations and exploitations, it will be understood that these embodiments are illustrative and that the scope of the inventive subject matter is not limited to them. In general, techniques for accelerating content loading as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for accelerating acquiring content over a network, the method comprising:
receiving, by a native application executable by one or more processors, an indication of one or more selected user interface elements;
determining, by the one or more processors, one or more content items to be loaded based, at least in part, on the indication of the one or more selected user interface elements; and
changing a priority associated with loading the one or more content items.

2. The method of claim 1, wherein receiving the indication of the one or more selected user interface elements includes determining the one or more selected user interface elements based, at least in part, on a gesture on a touchscreen interface.

3. The method of claim 2, wherein a first gesture increases the priority associated with the loading of the one or more content items and a second gesture decreases the priority associated with loading the one or more content items.

4. The method of claim 1, wherein receiving the indication of the one or more selected user interface elements includes determining the one or more selected user interface elements based, at least in part, on a selection of an input user interface element.

5. The method of claim 1, further comprising:
suspending loading of content other than the one or more content items while the one or more content items are loaded.

6. The method of claim 1, further comprising:
lowering a priority associated with loading of content other than the one or more content items while the one or more content items are loaded.

7. The method of claim 1, wherein said receiving the indication of one or more selected user interface elements occurs during processing of a current content item and further comprising:
loading the one or more content items at least partially during the processing of the current content item.

8. A computer program product for accelerating acquiring content over a network, the computer program product comprising a computer readable storage medium having program instructions embodied therewith, the program instructions executable by one or more processors of a device to cause the device to:
receive, by a native application, an indication of one or more selected user interface elements;
determine one or more content items to be loaded based, at least in part, on the indication of the one or more selected user interface elements; and
change a priority associated with loading the one or more content items.

9. The computer program product of claim 8, wherein the program instructions to receive the indication of the one or more selected user interface elements include program instructions to determine the one or more selected user interface elements based, at least in part, on a gesture on a touchscreen interface.

10. The computer program product of claim 9, wherein a first gesture increases the priority associated with the loading of the one or more content items and a second gesture decreases the priority associated with loading the one or more content items.

11. The computer program product of claim 8, wherein the program instructions to receive the indication of the one or more selected user interface elements include the program instructions to determine the one or more selected user interface elements based, at least in part, on a selection of an input user interface element.

12. The computer program product of claim 8, wherein the program instructions further comprise program instructions to:
suspend loading of content other than the one or more content items while the one or more content items are loaded.

13. The computer program product of claim 8, wherein the program instructions further comprise program instructions to:
lower a priority associated with loading of content other than the one or more content items while the one or more content items are loaded.

14. The computer program product of claim 8, wherein the program instructions further comprise program instructions to automatically provide the indication of one or more selected user interface elements based, at least in part, on a policy stored on the device.

15. A device comprising:
one or more processors; and
a computer readable storage medium communicably coupled to the one or more processors, the computer readable storage medium having stored thereon program instructions, that when executed, cause the device to:
receive, by a native application executing on the device, an indication of one or more selected user interface elements,
determine one or more content items to be loaded based, at least in part, on the indication of the one or more selected user interface elements, and
change a priority associated with loading the one or more content items.

16. The device of claim 15, wherein the program instructions to receive the indication of the one or more selected user interface elements include program instructions to determine the one or more selected user interface elements based, at least in part, on a gesture on a touchscreen interface.

17. The device of claim 16, wherein a first gesture increases the priority associated with the loading of the one or more content items and a second gesture decreases the priority associated with loading the one or more content items.

18. The device of claim 15, wherein the program instructions to receive the indication of the one or more selected user interface elements include the program instructions to determine the one or more selected user interface elements based, at least in part, on a selection of an input user interface element.

19. The device of claim 15, wherein the program instructions further comprise program instructions to:
suspend loading of content other than the one or more content items while the one or more content items are loaded.

20. The device of claim 15, wherein the program instructions further comprise program instructions to:
lower a priority associated with loading of content other than the one or more content items while the one or more content items are loaded.
